(19) United States
(12) Patent Application Publication
(10) Pub. No.: US 2026/0211857 A1
(43) Pub. Date: Jul. 23, 2026

(54) REPUTATION AND FEEDBACK-BASED CONFLICT RESOLUTION FOR LLM MEMORY BANKS

(71) Applicant: Dell Products L.P., Round Rock, TX (US)

(72) Inventors: Herberth Birck Fröhlich, Florianópolis (BR); Marcus Vinicius Libardi Pazini, Caxias do Sul (BR); Werner Spolidoro Freund, Rio de Janeiro (BR)

(21) Appl. No.: 19/034,413

(22) Filed: Jan. 22, 2025

(51) Int. Cl. G06F 16/215; G06F 16/23; G06F 40/35

(52) U.S. Cl. CPC G06F 16/215; G06F 16/2365; G06F 40/35

(57) ABSTRACT

One example method for implementing conflict resolution in an LLM (large language model) memory bank may be implemented, in whole or in part, by a mediator module, and may include receiving information from one or more sources concerning a task to be performed by an agent, extracting observations from the information, comparing one of the observations with an existing observation residing in a memory bank, identifying a conflict between the one observation and the existing observation, and, resolving the conflict based on reputations of respective sources that originated the observation and the existing observation.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to LLMs (large language models) and their operation. More particularly, at least some embodiments relate to systems, hardware, software, computer-readable media, and methods, for reputation and feedback-based conflict resolution for LLM memory banks.

### BACKGROUND

Large Language Models (LLM) based agents perform tasks and engage in interactions by seeking external resources when they cannot answer requests using locally available knowledge and tools. The usage of these agents often spans multiple sessions, requiring them to manipulate an efficient access memory to recall earlier pieces of information. In multi-agent multi-requester scenarios, a unified memory bank is essential for all agents to collaborate effectively.

The rationale behind incorporating memory mechanisms in LLM-based agents can be thought of in terms of self-evolution. That is, agents must accumulate experiences, explore their environment-which includes information sources- and abstract knowledge as they learn and grow. Memory mechanisms are important for supporting the role and functionality of an agent within its intended application. However, the inherent dynamicity and subjectivity of memory banks managed LLMs can result in challenges when it comes to conflict resolution, making traditional methods used in databases less effective.

In more detail, one approach to conflict resolution is rule-based, both for LLM memory banks and for databases. The admin/user sets a rule such as “if conflict, keep the last observation,” or for numerical ones “do the average if a conflict occurs.” Such an approach might lead to non-optimal behavior. One other alternative approach for conflict resolution is to use the most recent observation, or only the stored one, and let the agent carry out the task, conducting the conflict resolution after an occasional task failure. Although possible, this is not a reasonable approach since LLM-based agents are expensive-they require many LLM requests to solve a task.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of a method and schema, according to one embodiment.

FIG. 2 discloses aspects of a conflict detection pipeline, according to one embodiment.

FIG. 3 discloses an agent execution pipeline, according to one embodiment.

FIG. 4 discloses aspects of a reputation rollback procedure, according to one embodiment.

FIG. 5 discloses aspects of a computing entity configured and operable to perform any of the disclosed methods, processes, and operations.

### DETAILED DESCRIPTION OF SOME EXAMPLE EMBODIMENTS

Embodiments disclosed herein generally relate to LLMs (large language models) and their operation. More particularly, at least some embodiments relate to systems, hardware, software, computer-readable media, and methods, for reputation and feedback-based conflict resolution for LLM memory banks.

One or more example embodiments comprise methods, architectures, and/or, schemas, that implement reputation and feedback-based conflict resolution in memory banks used by LLMs. One example of such an LLM is a virtual assistant, such as a chatbot for example. Various other LLMs and associated applications are disclosed herein. However, the scope of this disclosure, and of any claims, is not limited to the disclosed illustrative examples.

One example method for implementing conflict resolution in an LLM (large language model) memory bank according to an embodiment may be implemented, in whole or in part, by a mediator module, and may comprise operations including: receiving information from one or more sources concerning a task to be performed by an agent; extracting observations from the information; comparing one of the observations with an existing observation residing in a memory bank; identifying a conflict between the one observation and the existing observation; and resolving the conflict based on reputations of respective sources that originated the observation and the existing observation.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect is that an embodiment may rank observation sources according to their respective reputation, and so improve a quality of execution of a task by an agent. An embodiment may incorporate a feedback loop to aid an agent in carrying out a task. Various other advantages of one or more example embodiments will be apparent from this disclosure.

### A. REFERENCES

Reference is made herein to the documents listed below. These documents are incorporated herein in their respective entireties by this reference.
[1] Z. Zhang, X. Bo, C. Ma, R. Li, X. Chen, Q. Dai, J. Zhu, Z. Dong and J.-r. Wen, “A survey on the memory mechanism of large language model based Agents,” Arxiv, 2024.
[2] L. Liu, X. Yang, Y. Shen, B. Hu, Z. Zhang, J. Gu and G. Zhang, “Think-in-Memory: Recalling and Post-Thinking Enable LLMs with Long-Term Memory,” ArXiv, 2023.
[3] C. Packer, S. Wooders, K. Lin, V. Fang, S. G. Patil and J. E. Gonzalez, “MemGPT: Towards LLMs as Operating Systems,” ArXiv, 2024.

### B. CONTEXT FOR ONE EMBODIMENT

One or more embodiments are concerned with LLM-based memory banks. Reference [1] discloses some information about the operation of an LLM-based memory bank, and some components, particularly:
Writing Mechanism: The process of projecting raw observations into memory contents. It is a composed pipeline where a method checks if the observation has relevant information, and a second one where the information is processed to cope with the memory bank customization.
Management Mechanism: all operations that aim to process the stored memory information.
Reading Mechanism: this is about retrieving relevant information from the memory bank to support agent execution. It requires the task, or context, as input to know what to retrieve.

Although not exclusively a Memory Mechanism, reference is made herein to the term ‘Bucketization.’ This term refers to the categorization of observations into a macro category to ensure it is stored in the appropriate ‘bucket.’ In the Think-in-Memory work (see [2]), this is done by a Locality Sensitive Hashing (LSH), coping with an infinite possibility of buckets and many incoming observations. For one embodiment at least, any method that aggregates similar sentences may be adequate.

### C. OVERVIEW OF ASPECTS OF ONE EMBODIMENT

### C.1 Introduction

To address issues, including those noted herein, stemming from the dynamic and subjective nature of memory mechanisms included in and/or used by LLM-based agents, an embodiment may comprise a reputation-based conflict resolution approach. In one embodiment, the method involves prioritizing memory items based on the analysis of the source reputation, which may serve as a proxy for source trustworthiness. In an embodiment, the conflict detection and resolution are carried out by a mediator module, which ensures that the most reliable piece of information is kept. An embodiment may comprise a feedback module that operates to consider the benefit of the doubt for less prominent observations, rolling back observations that received negative feedback. This mechanism of the feedback module helps to address situations where the most reliable and established information may no longer be applicable or accurate.

As such, one embodiment of a mediator module may comprise a special-purpose computer dedicated to performing, only, the specific defined set of operations disclosed herein for resolving conflicts in an LLM memory bank. As further disclosed herein, such a mediator module may help to improve selection of information used to generate a prompt executable by an agent, such as in response to a query for example. In this way, for example, the information provided to a user or other entity may be more relevant, and reputable, as compared with information that would be provided to the user using conventional approaches.

As exemplified above, and embodiment may serve to resolve observation conflicts to provide the best environment information for an LLM-based agent execution by optimizing the agent context. One embodiment may be particularly useful in multi-source (multiple observation sources) and multi-agent (multiple requesters) scenarios. In these scenarios, disagreements among sources may be common, such that a centralized system, as provided by one embodiment, is required to provide a noise resilient decision. It is noted that the reputation-based conflict resolution approach of one embodiment can potentially mitigate occurrences of malicious behavior by prioritizing trustworthy sources.

### C.2 Discussion

One example embodiment operates to calculate source reputation and manage observation conflicts based on such calculation. Thus, an embodiment may enhance the environmental information that is fundamentally needed for an agent, such as an LLM-based agent, to execute a task.

For the purposes of this disclosure, a ‘source’ embraces any entity that provides information candidates for memory banks storage in natural language format. A source may comprise, for example, other agents, ML (machine learning) models, human users, or sensors. On an embodiment, a source produces information that is considered as an observation only after scrutiny of that information by a memory writing mechanism. The observation holds only the useful elements from the whole information sentence.

Task and observations are sent to the mediator module, which then uses a memory reading mechanism to search and retrieve stored, task-related observations from the memory bank. The mediator conflict detection method compares the incoming observation with the stored observations. If no conflict is detected, observation and memory items are sent to the Agent for it to perform the task. If conflicts are detected, the mediator triggers the conflict resolution, where sources are compared and the source with the higher reputation of the two wins. The information arriving from the winning source proceeds for context building.

In an embodiment, initially discarded observations are not dropped but are stored along with the sources of origin, that is the sources that provided those discarded observations. The mediator keeps a conflict temporary database used by the feedback method. In this method, feedback from the agent is used to check if the choice of using the information coming from the higher reputation source was correct. If not, a rollback occurs, updating all involved source reputations.

As discussed above, and disclosed elsewhere as well, one or more embodiments may comprise various useful features and aspects, although no embodiment is required to possess any of such features or aspects. The following examples are illustrative, but not exhaustive.

An embodiment may comprise a mediator module and associated mediator method. An embodiment of a mediator module and/or method may operate to rank observation sources according to their reputation, which may take into account various factors such as, but not limited to, contribution, novelty and reliability. An embodiment of a mediator module and/or method may receive and incorporate feedback which may be used to enhance decision-making and resolution of memory conflicts.

### D. DETAILED DISCUSSION OF ASPECTS OF AN EMBODIMENT

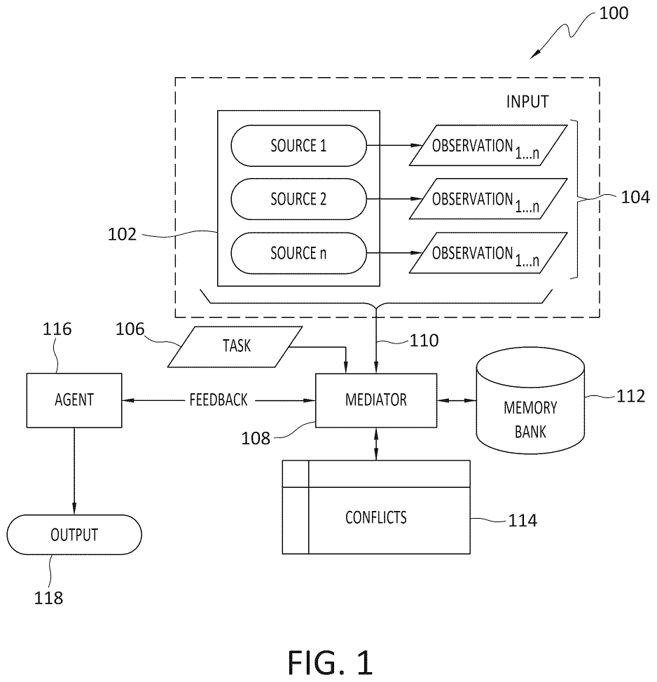

By way of introduction, FIG. 1 discloses an example schema 100 according to one embodiment. As shown, one or more sources 102 provide information that is processed to retrieve useful observations 104, that is, a bucket of observations, for a given task 106. A mediator module 108 compares the incoming observations 110 with existing observations in the memory bank 112. Based on respective reputations of the sources 102, the mediator module 108 resolves any conflicts that may occur as between the received observations 110. In an embodiment, initially ignored observations are not immediately discarded. A conflict bank 114 stores decisions for rollback purposes, depending on the feedback. After resolution of the conflict(s), the mediator module 108 may forward information, from the selected observation 104, to an agent 116, such as an LLM-based agent for example. That information may enable the agent 116 to carry out the task 106 and generate an output 118 that corresponds to, and may be defined in, the task 106.

### D.1 Input and Output Elements

As noted earlier herein, a ‘source’ 102 as used herein comprises the origin of one or more observations 104, and an embodiment may deal with any arbitrary type and number of sources 102. The observations 104 that come from each source 102 message is the relevant information that will be considered for the memory bank storage 112, provided by a writing mechanism. In this stage, a check is performed to determine if there are relevant elements in the observations 104 of each incoming source 102 message regarding a task to be executed. In an embodiment, a source 102 is not penalized for lacking elements relevant to a particular task 106. If an observation 104 from a source 102 is found, the writing mechanism attributes a unique ID (identifier) to that observation 104.

Following are some assumptions that may pertain to an embodiment. Particularly, an embodiment may assume the existence of a single, ongoing task 106 per run, with multiple possible sources 102 bringing relevant observations 104 for the agent 116 to carry out the task 106. It might be the case where an observation 104 is suitable for multiple tasks 106. Considering a task 106 as a bucket of relevant observations 104 is a way to narrow down conflict possibilities, and may be seen as a simplification.

### D.2 Mediator Module

Backed up by the memory mechanisms and the memory bank 112, the mediator module 108 deals with observation conflicts and manages source reputation scores. Following are examples of items that may be created in the memory bank 112:
Dictionary-like structures holding a list of observations 104 for a task 106, along with the content and the source that provided it; the task, in this case, is a bucket for a bucketization procedure.
   {taskName, [ObservationID, content, SourceID]}
      Example 1: {“room temperature setting”, [123, “Best room temperature during night is 19° Celsius”, “User1”]}
      Example 2: {“customer support assistance”, [234, “Customer X prefers to talk via phone about computer”, “Technician3”]}
Each Source 102 history for a task 106, containing the raw values for each reputation property (contribution, novelty, reliability, and any other use-case feature for customization) and the reputation score calculated from these properties with arbitrary weights:

| | |
|---|---|
| ∘ | SourceID = |
| | {TaskName, [Contribution, Novelty, Reliability, Custom], |
| | ReputationScore} |

| | |
|---|---|
| ▪ | Example: Technician3 = {“customer support assistance”, [4, |
| | 2, 6, None], 4} |

### D.2.1 Conflict Detection Method

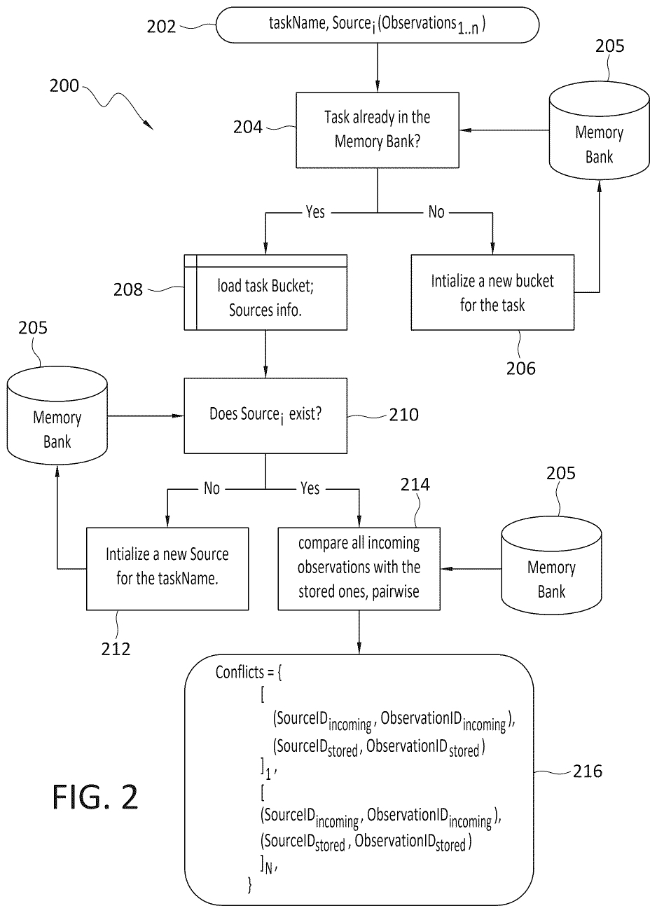

In conflict detection, an embodiment may leverage a memory management mechanism, which may be incorporated as an element of the memory bank 112, to detect conflicts between incoming observations 110 and observations already in the memory bank 112. With reference now to the example method 200 disclosed in FIG. 2, the following example conflict detection pipeline may be implemented in one embodiment:
1. Receive 202 the taskName for the ongoing session and all incoming Observations along with their respective Sources.
2. Check 204 to determine if a task is in the memory bank 205 or not, and if that task is not in the memory bank 205 bucket for the received taskName, a new bucket is initialized 206 for the task and stored in the memory bank 205. If the check 204 reveals that the task already exists in the memory bank 205, then the task bucket and sources information may be loaded 208.
3. Check 210 to determine if a source is in the memory bank 205 for the taskName and, if not, initialize 212 a new source entry for the taskName, and load the new source entry into the memory bank 205. The other Source fields remain empty at this moment as they are populated later.
4. Otherwise, if it is determined 210 source already exists in the memory bank 205 for that taskName, the management mechanism compares 214 all incoming observations with the ones stored for that taskName, pairwise.
5. The output 216 is a dictionary containing tuples of the conflicting peers of observations, along with their sources.

### D.2.2 Resolving Conflicts

After a conflict between observations has been detected, a mediator module of an embodiment may then implement various operations to resolve the conflict. Particularly, the conflict resolution method, which may be implemented by the mediator module, receives the conflict list from the memory mechanism of the memory bank, an example of which is indicated at 216 in FIG. 2. For each pair of conflicting observations, the respective source reputation scores are compared. Following are example Reputation properties that may be associated with a single Sourceᵢ:
Contribution: how many observations are stored for Sourceᵢ, resembling the presence of the source for that task.
Novelty: how many times an observation from Source; produced no conflicts, resembling the uniqueness of Source; for that task.
Reliability: how many times an Observation for Source; won a conflict, resembling trustworthiness.
Custom1 . . . . X: these are to cope with specific applications, and it is up to the user to fill. There might be more than one custom property.

The property should also be associated to a weight so the Reputation could be calculated via a weighted average, as depicted by Eq. 1:

$$SourceID\_Reputation = \frac{\begin{matrix}wC * Contribution * Novelty + wR * Reliability + wCusN * \\ CustomN\end{matrix}}{wC + wN + wR + WCusN} \qquad [ Eq . 1 ]$$

An embodiment may use an absolute Reputation score. The higher the weighted sum, the better. Here is a numerical example with no custom properties and all weights equal one:

$$Reputation = \frac{( 1 * 4 + 1 * 3 + 1 * 4 )}{1 + 1 + 1} = 3.67$$

The Reputation properties are updated every time that the Source is queried for information, even if the information provided Observations, or not, for that task. The output of the conflict resolution is the conflict list but with only the winning observations and related sources. As mentioned earlier, the losing observations are not immediately discarded but may be retained. The original conflict list (see FIG. 2) may be kept until feedback is provided.

If a tie between respective reputations of two sources occurs, each Source Reliabilities are compared. In an embodiment, this property is chosen for tie-breaking since Reliability directly relates to the number of won conflicts. If another tie occurs for the reliability property, Novelty is used; then Contribution. Ultimately, the most recent Observation is used. If observations from the same source are conflicting with each other, the last observation is kept, but this can be rolled back if the feedback module, discussed below, so indicates.

### D.2.3 Feedback Module

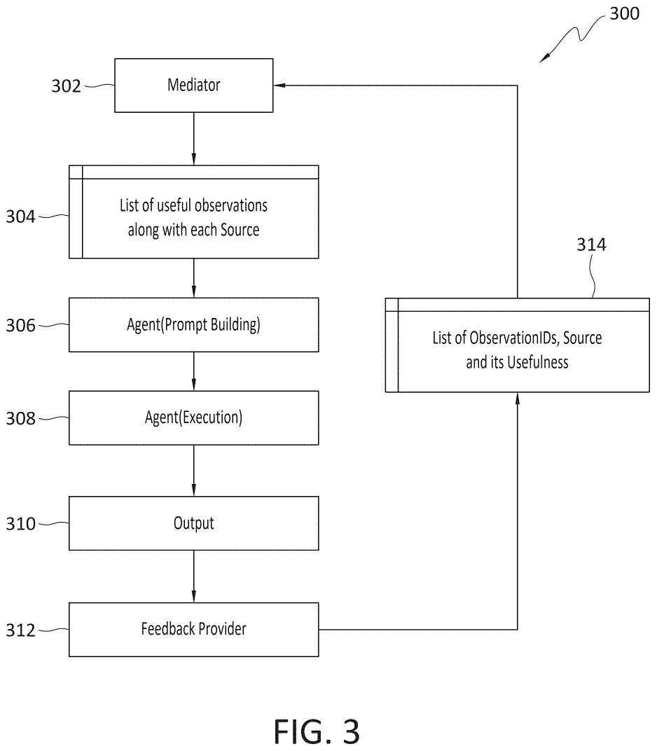

In an embodiment, all winning observations are properly added by the agent to its prompt. FIG. 3 discloses an example method 300 indicating how the observations flow through the pipeline until a reliable feedback provider sends back the observation list with a decision regarding the usefulness of each observation. This provider might be a human user, the agent itself through reasoning and reflection, another agent, an LLM-as a Judge, for example. Particularly, FIG. 3 discloses an agent execution pipeline considering feedback for the rolling back of reputation scores.

An embodiment may integrate a feedback stage to the agent execution. So, the observations IDs should persist along the agent execution:
1. Mediator 302 yields a list 304 containing all winning observations along with the originating sources.
2. Agent properly adds the observations 306 to its prompt.
3. The agent then executes the prompt 308 for the task to generate output 310.
4. Feedback 312 is produced from the task output. This feedback is a list 314 with all observations with a column with a Yes or No, or comparable positive/negative statement, representing the feedback for each observation.

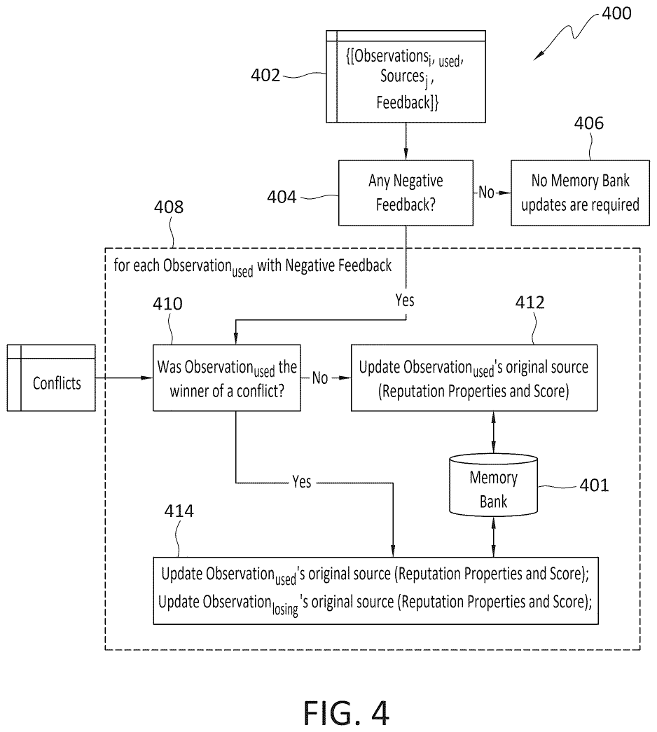

FIG. 4 discloses an example method 400 comprising various operations, such as a reputation rollback procedure, that may be performed after the feedback 402 from the method 300 is received. Initially, a check 404 is performed to determine if there is negative feedback. If all feedback is positive, no updates 406 are required, and the process stops. If there is any negative feedback, a loop 408 is initialized for each of those observations, namely, Observation_{used}.

In the loop 408, a check 410 is performed to determine if the current Observation used was part of a conflict. If not, only the source of it is updated 412. If the current Observation used was part of a conflict, all winning and losing sources are updated 414. The sources that originated the losing observations will have their reputation decreased accordingly. The previously winning observation, now with negative feedback, will have its source reputation decreased accordingly. All updates may be provided to the memory bank 401.

### D.3 Example

In this hypothetical example, a task of the agent is to schedule the room temperature for the night. However, the agent needs additional information to execute the task, which information is expected to come from the memory bank and/or from sources.

### 1. Task, Sources and Respective Messages.

Task: “Schedule AC room temperature for the baby to sleep.”; TaskName: “Room temperature for a baby during the night”.
User1: {“Message”: “The best room temperature for the baby is 22° C. During the day is 20° C.”, “Description”: “Room owner”}
User2: {“Message”: “The best room temperature for me is 24° C.”, “Description”: “Room owner”}
RoomTemperatureSensor1: {“Message”: “32° C.”, “Description”: “Sensor that measures the room temperature”}

### 2. Writing Mechanism

Considering the proposed task, the writing mechanism would hypothetically extract the following observations from the incoming messages:
User1 extracted Observation: “Baby; AC temperature, 22° C.” #Sentinel ignores the information about diurnal temperature since it is not task related.
User2 extracted Observation: Empty # The message lacks information about the baby and about the time of day thus is not relevant.
RoomTemperatureSensor1 extracted Observation: Empty #Sentinel found not useful to consider the current temperature. The agent might set the proper temperature for the night despite the current one.
   There is a single Source, User1, providing an observation for the mediator to analyze. This observation receives a unique ID. Going further, the mediator queries the memory bank for conflict detection.

### 3. Mediation

In this example, there is already a task with the same name in the memory bank, so no new bucket is required. There is also an observation for that task:
Tasks: {TaskName: “Room temperature for a baby during the night”, Observations: {[ID: 1, Content: “Baby room temperature during the night should be 20° C.”, Source: User2]}}
   The Conflict List for this example is:

```
Conflicts = {[
    (SourceID: User1, ObservationID: 2),
    (SourceID: User2 ObservationID: 1)
  ]}
```

Here, there is a conflict to be resolved. The sources properties at State₀ for the current task involved in the conflict are:
User1: {taskName: “Room temperature for a baby during the night.”, [Contribution: 0, Novelty: 0, Reliability: 0], Reputation: 0}
User2: {taskName: “Room temperature for a baby during the night.”, [Contribution: 1, Novelty: 1, Reliability: 0], Reputation: 0.666}
   These entries indicate that:
User1 has never provided a single observation for that task, hence the contribution is null and all other reputation fields as well.
User2 is historically active for that task—this Source has provided one observation that was new and used before.
   After reputation calculation, it is determined that User2 has the largest reputation; thus, the (incoming) User1's observation is not going to be used to solve the task. Reputations are updated since User2 won a conflict. This is the State₁:
User1: {taskName: “Room temperature for a baby during the night.”, [Contribution: 0, Novelty: 0, Reliability: 0], Reputation: 0}
User2: {taskName: “Room temperature for a baby during the night.”, [Contribution: 2, Novelty: 1, Reliability: 1], Reputation: 1.33}
   User2 Contribution was increased by one (the observation was used), and the reliability is increased (a conflict was won).

As noted earlier, the neglected observation is not discarded, as it goes to the conflict database for the benefit of doubt. The agent then adds the observation to its prompt. Hypothesizing that the feedback was “the temperature was good” then the “List of ObservationIDs, Source” and its Usefulness” would have a single observation with a Yes, which is not going to trigger the rollback. This would mean that the incoming observation from User1 was correctly denied.

In case of a negative feedback, the rolling back procedure takes place, and the reputation is recalculated from State₀:
User1: {taskName: “Room temperature for a baby during the night.”, [Contribution: 1, Novelty: 0, Reliability: 1], Reputation: 0.666}
User2: {taskName: “Room temperature for a baby during the night.”, [Contribution: 1, Novelty: 1, Reliability: 0], Reputation: 0.666}
   This new state shows the new contribution and reliability for the User1. Novelty was not increased since a conflict took place. Now, the memory bank is updated, ending the process.

### E. EXAMPLE METHODS

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### F. FURTHER EXAMPLE EMBODIMENTS

Following are some further example embodiments. These are presented only by way of example and are not intended to limit the scope of this disclosure or the claims in any way.
Embodiment 1. A method for implementing conflict resolution in an LLM (large language model) memory bank, comprising: receiving information from one or more sources concerning a task to be performed by an agent; extracting observations from the information; comparing one of the observations with an existing observation residing in a memory bank; identifying a conflict between the one observation and the existing observation; and resolving the conflict based on reputations of respective sources that originated the observation and the existing observation.
Embodiment 2. The method as recited in claim 1, wherein resolving the conflict comprises selecting, as a winning observation, whichever of the observation and the existing observation was originated by the source with a better reputation score as between the sources.
Embodiment 3. The method as recited in claim 2, wherein the winning observation is provided to the agent and is usable, by the agent, to generate a prompt that corresponds to the task.
Embodiment 4. The method as recited in claim 2, wherein whichever of the sources that originated the winning observation has its reputation score increased, and whichever of the sources that did not originate the winning observation has its reputation score decreased.
Embodiment 5. The method as recited in claim 2, wherein whichever of the observation and the existing observation is not the winning observation is retained in a temporary database for use in a feedback operation concerning whether or not use of the winning observation by the agent was correct.
Embodiment 6. The method as recited in claim 1, wherein the task comprises a bucket of observations.
Embodiment 7. The method as recited in claim 1, wherein the agent comprises an LLM-based agent.
Embodiment 8. The method as recited in claim 1, wherein an output of the agent, after performing the task, is used by a feedback provider to modify a list of observations to indicate a usefulness of an observation that was used by the agent to carry out the task.
Embodiment 9. The method as recited in claim 1, wherein the sources are ranked according to respective reputations of the sources, and the respective reputations of the sources account for factors pertaining to the sources that include contribution, novelty, and reliability.
Embodiment 10. The method as recited in claim 1, wherein the receiving information, extracting observations, comparing, identifying, and resolving, are performed by a mediator module that is operable to communicate with the memory bank and with the agent.
Embodiment 11. A system, comprising hardware and/or software, operable to perform any of the operations, methods, or processes, or any portion of any of these, disclosed herein.
Embodiment 12. A non-transitory storage medium having stored therein instructions that are executable by one or more hardware processors to perform operations comprising the operations of any one or more of embodiments 1-10.

### G. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

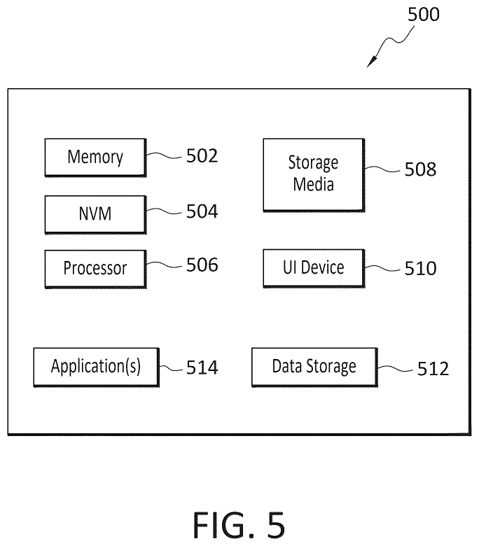

With reference briefly now to FIG. 5, any one or more of the entities disclosed, or implied, by FIGS. 1-4, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

1. A method for implementing conflict resolution in an LLM (large language model) memory bank, comprising:
receiving information from one or more sources concerning a task to be performed by an agent;
extracting observations from the information;
comparing one of the observations with an existing observation residing in a memory bank;
identifying a conflict between the one observation and the existing observation;
resolving the conflict based on reputations of respective sources that originated the observation and the existing observation; and
after feedback from performing the task is received, performing a reputation rollback procedure such that if a current observation used was part of a conflict, all winning and losing sources are updated, and the updates are provided to the memory bank.

2. The method as recited in claim 1, wherein resolving the conflict comprises selecting, as a winning observation, whichever of the observation and the existing observation was originated by the source with a better reputation score as between the sources.

3. The method as recited in claim 2, wherein the winning observation is provided to the agent and is usable, by the agent, to generate a prompt that corresponds to the task.

4. The method as recited in claim 2, wherein whichever of the sources that originated the winning observation has its reputation score increased, and whichever of the sources that did not originate the winning observation has its reputation score decreased.

5. The method as recited in claim 2, wherein whichever of the observation and the existing observation is not the winning observation is retained in a temporary database for use in a feedback operation concerning whether or not use of the winning observation by the agent was correct.

6. The method as recited in claim 1, wherein the task comprises a bucket of observations.

7. The method as recited in claim 1, wherein the agent comprises an LLM-based agent.

8. The method as recited in claim 1, wherein an output of the agent, after performing the task, is used by a feedback provider to modify a list of observations to indicate a usefulness of an observation that was used by the agent to carry out the task.

9. The method as recited in claim 1, wherein the sources are ranked according to respective reputations of the sources, and the respective reputations of the sources account for factors pertaining to the sources that include contribution, novelty, and reliability.

10. (canceled)

11. A non-transitory storage medium having stored therein instructions that are executable by one or more hardware processors to perform operations comprising:
receiving information from one or more sources concerning a task to be performed by an agent;
extracting observations from the information;
comparing one of the observations with an existing observation residing in a memory bank;
identifying a conflict between the one observation and the existing observation;
resolving the conflict based on reputations of respective sources that originated the observation and the existing observation; and
after feedback from performing the task is received, performing a reputation rollback procedure such that if a current observation used was part of a conflict, all winning and losing sources are updated, and the updates are provided to the memory bank.

12. The non-transitory storage medium as recited in claim 11, wherein resolving the conflict comprises selecting, as a winning observation, whichever of the observation and the existing observation was originated by the source with a better reputation score as between the sources.

13. The non-transitory storage medium as recited in claim 12, wherein the winning observation is provided to the agent and is usable, by the agent, to generate a prompt that corresponds to the task.

14. The non-transitory storage medium as recited in claim 12, wherein whichever of the sources that originated the winning observation has its reputation score increased, and whichever of the sources that did not originate the winning observation has its reputation score decreased.

15. The non-transitory storage medium as recited in claim 12, wherein whichever of the observation and the existing observation is not the winning observation is retained in a temporary database for use in a feedback operation concerning whether or not use of the winning observation by the agent was correct.

16. The non-transitory storage medium as recited in claim 11, wherein the task comprises a bucket of observations.

17. The non-transitory storage medium as recited in claim 11, wherein the agent comprises an LLM-based agent.

18. The non-transitory storage medium as recited in claim 11, wherein an output of the agent, after performing the task, is used by a feedback provider to modify a list of observations to indicate a usefulness of an observation that was used by the agent to carry out the task.

19. The non-transitory storage medium as recited in claim 11, wherein the sources are ranked according to respective reputations of the sources, and the respective reputations of the sources account for factors pertaining to the sources that include contribution, novelty, and reliability.

20. (canceled)

21. The method as recited in claim 1, wherein, prior to comparing the one observation with the existing observation, a memory management mechanism checks whether a task bucket corresponding to a received taskName exists in the memory bank and, if the task bucket does not exist, initializes and stores a new bucket for the task in the memory bank, and further checks whether a source entry corresponding to the taskName exists and, if the source entry does not exist, initializes and loads a new source entry into the memory bank.

22. The method as recited in claim 1, wherein extracting observations from the information comprises, by a memory writing mechanism, scrutinizing information produced by a source such that the information is considered an observation only after scrutiny, and wherein the observation holds only selected elements from a whole information sentence, and wherein observations initially discarded during conflict resolution are stored, along with their respective sources of origin, in a conflict temporary database for use in a subsequent feedback-based rollback procedure.
